(19) United States
(12) Patent Application Publication
(10) Pub. No.: US 2021/0299652 A1
(43) Pub. Date: Sep. 30, 2021

(54) LIQUID HANDLING DEVICE AND LIQUID HANDLING METHOD

(71) Applicant: Enplas Corporation, Kawaguchi-shi (JP)

(72) Inventor: Takumi Yamauchi, Saitama (JP)

(21) Appl. No.: 17/213,278

(22) Filed: Mar. 26, 2021

(30) Foreign Application Priority Data
Mar. 26, 2020 (JP) 2020-055818

(51) Int. Cl. B01L 3/00

(52) U.S. Cl. CPC B01L 3/5027; B01L 2300/0861; B01L 2300/0816; B01L 2200/0652

(57) ABSTRACT

A liquid handling device includes a main channel configured to carry main liquid, a first sheath liquid channel that opens to a bottom surface of the main channel, the first sheath liquid channel being configured to carry sheath liquid, and a second sheath liquid channel that opens to a top surface of the main channel, the second sheath liquid channel being configured to carry the sheath liquid. At least one of a confluence part of the first sheath liquid channel with the main channel and a confluence part of the second sheath liquid channel with the main channel is made up of the substrate and a curved portion of the film, the curved portion of the film being curved in a direction away from the substrate.

### CROSS REFERENCE TO RELATED APPLICATIONS

This application is entitled to the benefit of Japanese Patent Application No. 2020-055818, filed on Mar. 26, 2020, the disclosure of which including the specification, drawings and abstract is incorporated herein by reference in its entirety.

### TECHNICAL FIELD

The present invention relates to a liquid handling device and a liquid handling method for forming a sheath flow.

### BACKGROUND ART

In recent years, channel chips have been used for the analysis of cells, proteins, nucleic acids, and other substances. The advantage of flow chips is that the amount of sample and reagents required for analysis can be reduced, and they are expected to be used in various applications such as clinical, food, and environmental testing.

For example, PTL 1 discloses a channel chip for sorting microparticles (e.g., cells) in a liquid flowing through a main channel and extracting only the desired microparticles. The channel chip disclosed in PTL 1 is manufactured by laminating three substrates in which predetermined grooves and through holes are formed. In this channel chip, two sheath liquid channels in which the sheath liquid flows are joined, from both sides, to the sample liquid channel in which the sample liquid containing microparticles flows. Thus, the sheath liquid joining the sample liquid from both sides forms a sheath flow in which the laminar flow of the sample liquid is sandwiched between the two laminar flows of the sheath liquid in the main flow channel located downstream of the confluence point.

### CITATION LIST

### Patent Literature

PTL 1

Japanese Patent Application Laid-Open No. 2014-036604

### SUMMARY OF INVENTION

### Technical Problem

The channel chip disclosed in PTL 1 is manufactured by laminating as many as three substrates, which results in a large manufacturing cost. In addition, the channel chip disclosed in PTL 1 forms a three-layered sheath flow in which the laminar flow of the sample liquid is sandwiched between two laminar flows of sheath liquid, but depending on the use, it may be desired to form a two-layered sheath flow in which the laminar flow of the sample liquid is surrounded by the laminar flow of sheath liquid.

An object of the present invention is to provide a liquid handling device including a substrate and a film joined to the substrate and can form the sheath flow in which the sheath liquid surrounds the main liquid. In addition, another object of the present invention is to provide a liquid handling method of forming the sheath flow using the liquid handling device.

### Solution to Problem

A liquid handling device of an embodiment of the present invention is configured to form a sheath flow including main liquid and sheath liquid surrounding the main liquid, the liquid handling device including: a substrate; a film joined to the substrate; a main channel configured to carry the main liquid; a first sheath liquid channel that opens to a bottom surface of the main channel, the first sheath liquid channel being configured to carry the sheath liquid; and a second sheath liquid channel that opens to a top surface of the main channel, the second sheath liquid channel being configured to carry the sheath liquid. At least one of a confluence part of the first sheath liquid channel with the main channel and a confluence part of the second sheath liquid channel with the main channel is made up of the substrate and a curved portion of the film, the curved portion of the film being curved in a direction away from the substrate.

A liquid handling method of an embodiment of the present invention is a method of forming a sheath flow using the liquid handling device, the liquid handling method including: forming a sheath flow including the main liquid and the sheath liquid surrounding the main liquid by carrying the main liquid in the main channel and carrying the sheath liquid in the first sheath liquid channel and the second sheath liquid channel.

### Advantageous Effects of Invention

According to the present invention, the sheath flow in which the sheath liquid surrounds the main liquid can be formed using a simple device.

### BRIEF DESCRIPTION OF DRAWINGS

FIG. 1 is a perspective view of a liquid handling device according to Embodiment 1;

FIG. 2 is an exploded perspective view of the liquid handling device;

FIG. 3A is a plan view of the liquid handling device, and FIG. 3B is a sectional view taken along line A-A of FIG. 3A;

FIG. 4A is a sectional view taken along line B-B of FIG. 3A, FIG. 4B is a sectional view taken along line C-C of FIG. 3A, and FIG. 4C is a sectional view taken along line D-D of FIG. 3A;

FIG. 5A is a drawing illustrating main liquid and sheath liquid at a confluence part of a main channel and a first sheath liquid channel, FIG. 5B is a drawing illustrating the main liquid and the sheath liquid at a confluence part of the main channel and a second sheath liquid channel, and FIG. 5C is a drawing illustrating the main liquid and the sheath liquid in the main channel downstream of the confluence part of the main channel and the second sheath liquid channel;

FIG. 6 is a perspective view of a liquid handling device according to Embodiment 2;

FIG. 7A is a plan view of the liquid handling device, and FIG. 7B is a sectional view taken along line A-A of FIG. 7A;

FIG. 8A is a sectional view taken along line B-B of FIG. 7A, FIG. 8B is a sectional view taken along line C-C of FIG. 7A, and FIG. 8C is a sectional view taken along line D-D of FIG. 7A;

FIG. 9 is a perspective view of a liquid handling device according to Embodiment 3;

FIG. 10A is a plan view of the liquid handling device, and FIG. 10B is a sectional view taken along line A-A of FIG. 10A;

FIG. 11A is a sectional view taken along line B-B of FIG. 10A, FIG. 11B is a sectional view taken along line C-C of FIG. 10A, and FIG. 11C is a sectional view taken along line D-D of FIG. 10A;

FIG. 12 is a perspective view of a liquid handling device according to Embodiment 4;

FIG. 13 is an exploded perspective view of the liquid handling device;

FIG. 14A is a plan view of the liquid handling device, and FIG. 14B is a sectional view taken along line A-A of FIG. 14A;

FIG. 15A is a sectional view taken along line B-B of FIG. 14A, FIG. 15B is a sectional view taken along line C-C of FIG. 14A, and FIG. 15C is a sectional view taken along line D-D of FIG. 14A; and

FIG. 16A is a drawing illustrating main liquid and sheath liquid at a confluence part of a main channel and a first sheath liquid channel, FIG. 16B is a drawing illustrating the main liquid and the sheath liquid at a confluence part of the main channel and a second sheath liquid channel, and FIG. 16C is a drawing illustrating the main liquid and the sheath liquid in the main channel downstream of the confluence part of the main channel and the second sheath liquid channel

### DESCRIPTION OF EMBODIMENTS

### Embodiment 1

### Configuration of Liquid Handling Device

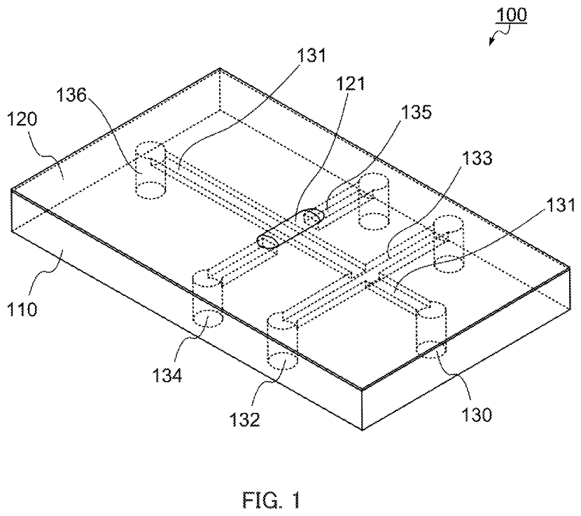

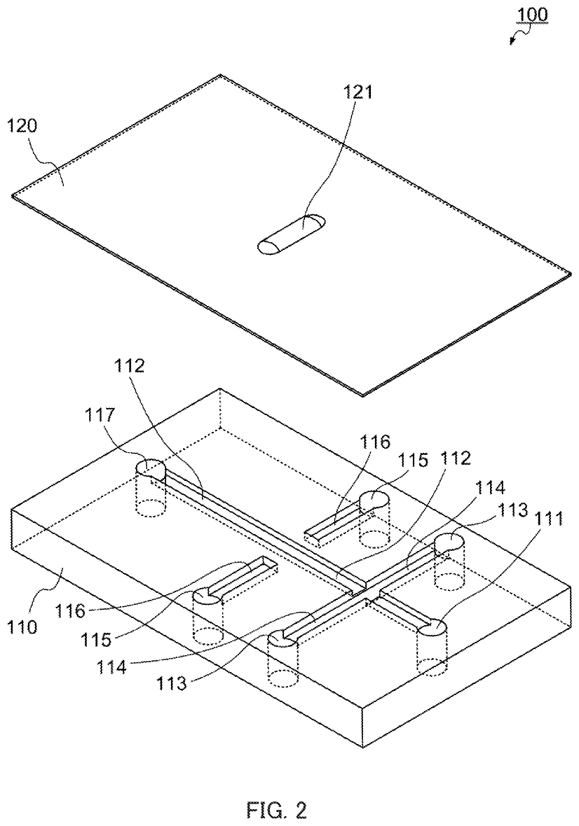

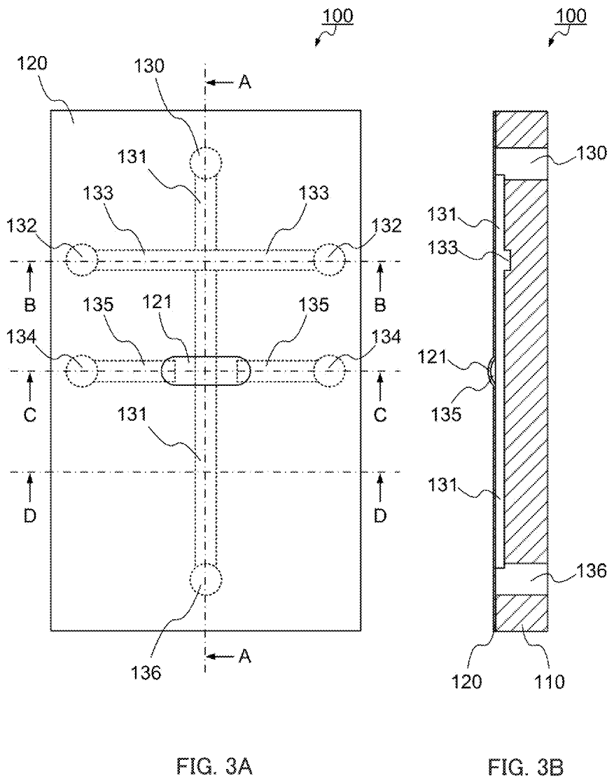

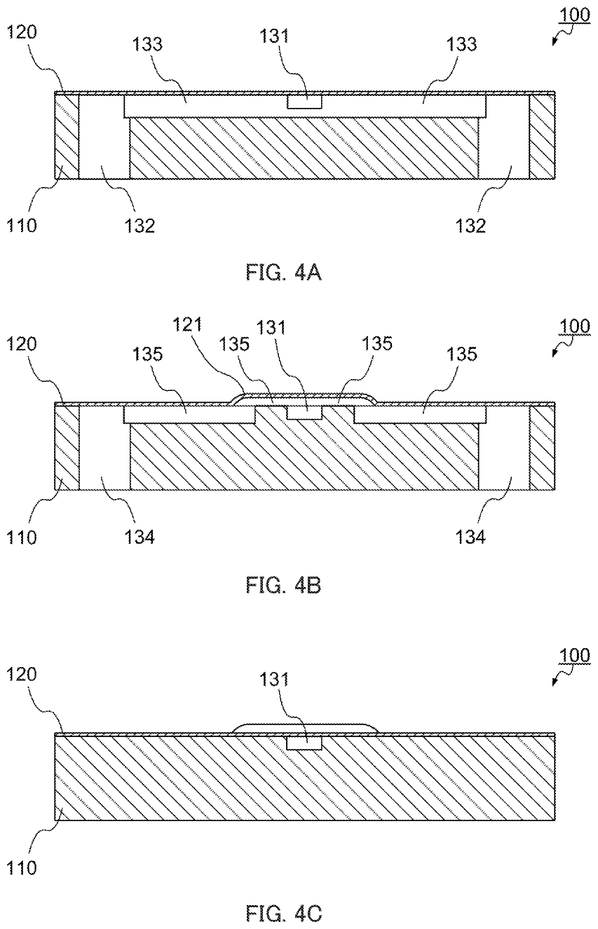

FIG. 1 is a perspective view of liquid handling device 100 according to Embodiment 1. FIG. 2 is an exploded perspective view of liquid handling device 100. FIG. 3A is a plan view of liquid handling device 100, and FIG. 3B is a sectional view taken along line A-A of FIG. 3A. FIG. 4A is a sectional view taken along line B-B of FIG. 3A, FIG. 4B is a sectional view taken along line C-C of FIG. 3A, and FIG. 4C is a sectional view taken along line D-D of FIG. 3A.

As illustrated in these drawings, liquid handling device 100 includes substrate 110 and film 120. In substrate 110, a groove configured to be a channel and a through hole configured to be an inlet or an outlet are formed. Film 120 is joined to one surface of substrate 110 to close the openings of the groove and the through hole formed in substrate 110. A part of the region of film 120 is formed as curved portion 121 curved in a direction away from substrate 110. The groove of substrate 110 closed with film 120 serves as a channel for carrying main liquid or sheath liquid. In addition, the inner space of curved portion 121 also serves as a channel for carrying sheath liquid.

The thickness of substrate 110 is not limited. For example, the thickness of substrate 110 is 1 mm to 10 mm. In addition, the material of substrate 110 is not limited.

For example, the material of substrate 110 is appropriately selected from publicly known resins and glass. Examples of the material of substrate 110 include polyethylene terephthalate, polycarbonate, polymethylmethacrylate, polyvinyl chloride, polypropylene, polyether, polyethylene, polystyrene, cycloolefin resin, silicone resin and elastomer.

The thickness of film 120 is not limited as long as a required strength can be ensured. For example, the thickness of film 120 is 30 μm to 300 μm. In addition, the material of film 120 is not limited as long as curved portion 121 can be molded. For example, the material of film 120 is appropriately selected from publicly known resins. Examples of the material of film 120 include polyethylene terephthalate, polycarbonate, polymethylmethacrylate, polyvinyl chloride, polypropylene, polyether, polyethylene, polystyrene, cycloolefin resin, silicone resin and elastomer. For observation of the main liquid flowing inside the channel, it is preferable that the material of film 120 be transparent. In addition, for fluorescence observation of the main liquid flowing inside the channel, it is preferable that the material of film 120 be a material that transmits excitation light and fluorescence, with low autofluorescence. Film 120 is joined to substrate 110 by, for example, thermal welding, laser welding, an adhesive agent and the like.

In the present embodiment, liquid handling device 100 includes main liquid introduction part 130, main channel 131, two first sheath liquid introduction parts 132, two first sheath liquid channels 133, two second sheath liquid introduction parts 134, two second sheath liquid channels 135, and liquid ejection part 136.

Main liquid introduction part 130 is a bottomed recess to which main liquid is introduced. In the present embodiment, main liquid introduction part 130 is composed of first through hole 111 formed in substrate 110, and a part of film 120 that closes one opening of first through hole 111 (see FIG. 2). The shape and the size of first through hole 111 are not limited, and may be appropriately set in accordance with the use. The shape of first through hole 111 is, for example, a substantially columnar shape. The diameter of first through hole 111 is, for example, approximately 2 mm

The type of the main liquid that is introduced to main liquid introduction part 130 is not limited. For example, the main liquid is cell suspension, DNA-containing liquid, RNA-containing liquid, or the like. The main liquid may be liquid containing (sample liquid) a sample such as blood or an analyte such as cells and nucleic acids, liquid containing reagent, beads and the like, or a mixture of liquid containing an analyte and liquid containing reagent, beads and the like.

Main channel 131 is a channel in which liquid can move. The upstream end of main channel 131 is connected to main liquid introduction part 130, and the downstream end of main channel 131 is connected to liquid ejection part 136. In addition, as described later, first sheath liquid channel 133 and second sheath liquid channel 135 are connected to main channel 131 at respective positions different from each other. In the present embodiment, the main liquid is introduced from main liquid introduction part 130 to main channel 131, and the sheath liquid is introduced from the confluence part with first sheath liquid channel 133 and the confluence part with second sheath liquid channel 135. Accordingly, the main liquid flows in main channel 131 in the region from main liquid introduction part 130 to the confluence part with first sheath liquid channel 133, and the main liquid and the sheath liquid flow in main channel 131 in the region from the confluence part with first sheath liquid channel 133 to liquid ejection part 136. As described later, in the region from the confluence part with second sheath liquid channel 135 to liquid ejection part 136, the main liquid and the sheath liquid flow in main channel 131 in a sheath flow state in which the sheath liquid surrounds the main liquid.

Main channel 131 is composed of first groove 112 formed in substrate 110 and a part of film 120 that closes the opening of first groove 112 (see FIG. 2). The cross-sectional area and the cross-sectional shape of first groove 112 are not limited as long as the sheath flow in which the sheath liquid surrounds the main liquid can be formed in main channel 131. The “cross-section of a channel or a groove” as used herein means the cross-section of the channel or the groove orthogonal to the direction in which the liquid flows. The cross-sectional shape of first groove 112 is, for example, a substantially rectangular shape with each side having a length (width and depth) of approximately several tens of micrometers. The cross-sectional area of first groove 112 may be or may not be constant in the flow direction of the liquid. In the present embodiment, the cross-sectional area of first groove 112 is constant.

Two first sheath liquid introduction parts 132 and two second sheath liquid introduction parts 134 are bottomed recesses to which the sheath liquid is introduced. In the present embodiment, each of two first sheath liquid introduction parts 132 is composed of second through hole 113 formed in substrate 110 and a part of film 120 that closes one opening of second through hole 113 (see FIG. 2). In addition, each of two second sheath liquid introduction parts 134 is composed of third through hole 115 formed in substrate 110 and a part of film 120 that closes one opening of third through hole 115 (see FIG. 2). The shape and the size of each of second through hole 113 and third through hole 115 are not limited, and may be appropriately set in accordance with the use. The shape of each of second through hole 113 and third through hole 115 is, for example, a substantially columnar shape. The diameter of each of second through hole 113 and third through hole 115 is, for example, approximately 2 mm

The type of the sheath liquid introduced to first sheath liquid introduction part 132 and second sheath liquid introduction part 134 is not limited. For example, the sheath liquid is physiological saline, buffer solution, or the like. For fluorescence observation of the main liquid flowing inside the channel, it is preferable that the sheath liquid be liquid with low optical interference.

Two first sheath liquid channels 133 are channels in which liquid can move. The upstream ends of two first sheath liquid channels 133 are connected to respective first sheath liquid introduction parts 132 different from each other, and the downstream ends of two first sheath liquid channels 133 are connected to main channel 131. In first sheath liquid channel 133, the sheath liquid introduced to first sheath liquid introduction part 132 flows. First sheath liquid channel 133 opens at least to the bottom surface of main channel 131. In the present embodiment, the “bottom surface of a channel” means a surface opposite to film 120 in the inner surfaces of the channel In the present embodiment, two first sheath liquid channels 133 open not only to the bottom surface of main channel 131 but also to side surfaces of main channel 131 opposing each other (see FIGS. 2 and 4A). The openings of two first sheath liquid channels 133 at the bottom surface of main channel 131 are a common opening. The openings of two first sheath liquid channels 133 at the side surfaces of main channel 131 are opposite to each other.

Each of two first sheath liquid channels 133 is composed of second groove 114 formed in substrate 110 and a part of film 120 that closes the opening of second groove 114 (see FIG. 2). The cross-sectional area and the cross-sectional shape of second groove 114 is not limited as long as an appropriate amount of the sheath liquid for forming the sheath flow can be introduced at an appropriate position of main channel 131. The cross-sectional shape of second groove 114 is, for example, a substantially rectangular shape with each side having a length (width and depth) of approximately several tens of micrometers. The cross-sectional area of second groove 114 may be or may not be constant in the flow direction of the liquid. In the present embodiment, the cross-sectional area of second groove 114 is constant.

Two second sheath liquid channels 135 are channels in which liquid can move. The upstream ends of two second sheath liquid channels 135 are connected to respective second sheath liquid introduction parts 134 different from each other, and the downstream ends of two second sheath liquid channels 135 are connected to main channel 131. The sheath liquid introduced to second sheath liquid introduction part 134 flows in second sheath liquid channel 135. Second sheath liquid channel 135 opens at least to the top surface of main channel 131. In the present embodiment, the “top surface of a channel” means a surface on film 120 side (the surface formed with film 120) of the inner surfaces of the channel In the present embodiment, two second sheath liquid channels 135 open only to the top surface of main channel 131 (see FIG. 4B). The openings of two second sheath liquid channels 135 at the top surface of main channel 131 are a common opening.

Except for the portion of the confluence part with main channel 131, second sheath liquid channel 135 is composed of third groove 116 formed in substrate 110 and a part of film 120 that closes the opening of third groove 116 (see FIGS. 2 and 4B). As illustrated in FIG. 2, third groove 116 is not connected to first groove 112. The cross-sectional area and the cross-sectional shape of third groove 116 are not limited as long as an appropriate amount of the sheath liquid for forming the sheath flow can be introduced to main channel 131. The cross-sectional shape of third groove 116 is, for example, a substantially rectangular shape with each side having a length (width and depth) of approximately several tens of micrometers. The cross-sectional area of third groove 116 may be or may not be constant in the flow direction of the liquid. In the present embodiment, the cross-sectional area of third groove 116 is constant.

The confluence part of second sheath liquid channel 135 with main channel 131 is composed of a part of one surface of substrate 110 (the surface on which film 120 is joined), a part of the opening of first groove 112 (the groove that makes up main channel 131), and curved portion 121 of film 120 (see FIGS. 2 and 4B). As described above, curved portion 121 is a portion provided in film 120 and curved (recessed) in a direction away from substrate 110. Curved portion 121 faces the surface, of substrate 110, where the groove is not formed, but is not joined on substrate 110. Accordingly, the sheath liquid flowing in from the portion between third groove 116 and film 120 is introduced into main channel 131 from the top surface side of main channel 131 through the space between substrate 110 and curved portion 121. The shape and the size of curved portion 121 are not limited as long as an appropriate amount of the sheath liquid for forming the sheath flow can be introduced to main channel 131. In the present embodiment, the shape of curved portion 121 in plan view is a substantially ellipsoidal shape (a shape with two parallel lines of the same length and two semicircles)(see FIG. 3A). The cross-sectional shape of curved portion 121 taken along the minor axis direction is a substantially arc shape (see FIG. 3B).

Note that while the confluence part of two first sheath liquid channels 133 is located upstream of the confluence part of two second sheath liquid channels 135 in main channel 131 in the present embodiment, the positions of these confluence parts are not limited to this. For example, the confluence part of two second sheath liquid channels 135 may be disposed upstream of the confluence part of two first sheath liquid channels 133. In addition, the confluence part of two first sheath liquid channels 133 may face the confluence part of two second sheath liquid channels 135.

Liquid ejection part 136 is a bottomed recess for removing the sheath liquid and the main liquid flowing in from main channel 131 in the sheath flow state. In the present embodiment, liquid ejection part 136 is composed of fourth through hole 117 formed in substrate 110 and a part of film 120 that closes one opening of fourth through hole 117 (see FIG. 2). The shape and the size of fourth through hole 117 are not limited, and may be appropriately set in accordance with the use. The shape of fourth through hole 117 is, for example, a substantially columnar shape. The diameter of fourth through hole 117 is, for example, approximately 2 mm

### Operation of Liquid Handling Device

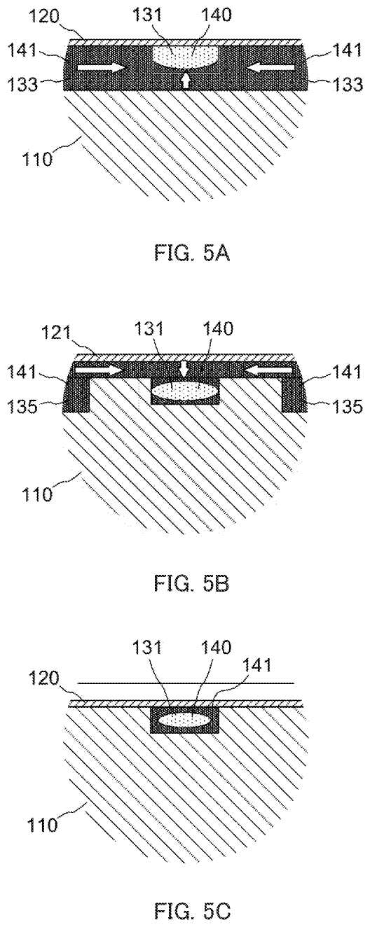

Next, with reference to FIGS. 5A to 5C, an operation (liquid handling method) of liquid handling device 100 is described.

The main liquid is introduced to main liquid introduction part 130, and the sheath liquid is introduced to two first sheath liquid introduction parts 132 and two second sheath liquid introduction parts 134. In this state, liquid ejection part 136 is depressurized, or a pressure is exerted on main liquid introduction part 130, two first sheath liquid introduction parts 132 and two second sheath liquid introduction parts 134. In this manner, the main liquid in main liquid introduction part 130 flows in main channel 131 toward liquid ejection part 136. In addition, the sheath liquid in first sheath liquid introduction part 132 flows in first sheath liquid channel 133 toward main channel 131, and the sheath liquid in second sheath liquid introduction part 134 flows in second sheath liquid channel 135 toward main channel 131.

FIG. 5A is a drawing illustrating main liquid 140 and sheath liquid 141 at the confluence part between main channel 131 and two first sheath liquid channels 133 (which corresponds to a partially enlarged view of the vicinity of main channel 131 illustrated in FIG. 4A). As illustrated in this drawing, two first sheath liquid channels 133 open to the bottom surface and two side surfaces of main channel 131, and therefore, at the confluence part between main channel 131 and two first sheath liquid channels 133, sheath liquid 141 flowing in from two first sheath liquid channels 133 is located on the lateral side and the lower side of main liquid 140 in main channel 131, but not located on the upper side. In main channel 131, main liquid 140 and sheath liquid 141 flows in a laminar flow state.

FIG. 5B is a drawing illustrating main liquid 140 and sheath liquid 141 at the confluence part between main channel 131 and two second sheath liquid channels 135 (which corresponds to a partially enlarged view of the vicinity of main channel 131 illustrated in of FIG. 4B). As illustrated in this drawing, since two second sheath liquid channels 135 open to the top surface of main channel 131, sheath liquid 141 flowing in from two second sheath liquid channels 135 is located on the upper side of main liquid 140 in main channel 131 at the confluence part between main channel 131 and two second sheath liquid channels 135. In main channel 131, sheath liquid 141 flowing in from two second sheath liquid channels 135 also flows in a laminar flow state.

FIG. 5C is a drawing illustrating main liquid 140 and sheath liquid 141 in main channel 131 downstream of the confluence part between main channel 131 and two second sheath liquid channels 135 (which corresponds to a partially enlarged view of the vicinity of main channel 131 illustrated in FIG. 4C). As described above, sheath liquid 141 flowing in from two first sheath liquid channels 133 is located on the lateral side and the lower side of main liquid 140 in main channel 131 (see FIG. 5A), and sheath liquid 141 flowing in from two second sheath liquid channels 135 is located on the upper side of main liquid 140 in main channel 131 (see FIG. 5B). As a result, as illustrated in FIG. 5C, a sheath flow in which sheath liquid 141 surrounds main liquid 140 is formed. Here “the sheath liquid surrounds the main liquid” means that sheath liquid surrounds the whole circumference of the main liquid in a cross-section orthogonal to the flow direction of main channel 131.

Observation or fluorescence observation of main liquid 140 may be performed in the state where the sheath flow is formed in main channel 131 as illustrated in FIG. 5C. Since main liquid 140 stably flows in the state where it is surrounded by sheath liquid 141 without making contact with the inner wall of main channel 131, main liquid 140 can be stably observed.

### Effect

As described above, liquid handling device 100 according to the present embodiment can stably form a sheath flow in which the sheath liquid surrounds the main liquid with a configuration that can be manufactured with film 120 at low cost. In addition, the volume ratio of the main liquid and the sheath liquid can be readily controlled by adjusting the shape of curved portion 121.

In addition, in fluorescence observation of the main liquid in main channel 131, the influence of autofluorescence can be reduced since film 120 is used in place of a substrate, and the degree of freedom of the working distance can be increased since film 120 has a small thickness.

### Embodiment 2

Liquid handling device 200 according to Embodiment 2 is different from liquid handling device 100 according to Embodiment 1 only in configuration of curved portion 221. The same components as those of liquid handling device 100 according to Embodiment 1 are denoted by the same reference numerals, and the descriptions thereof are omitted.

### Configuration of Liquid Handling Device

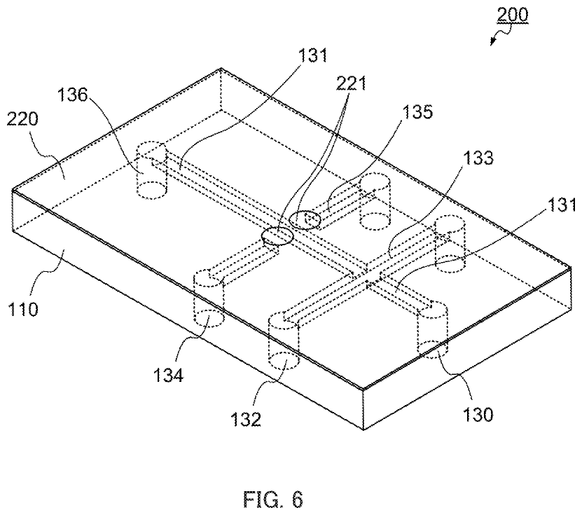

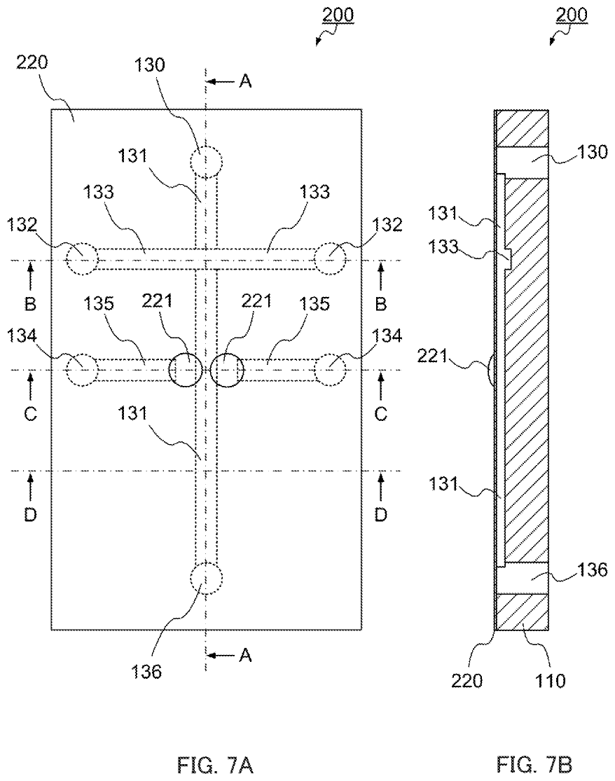

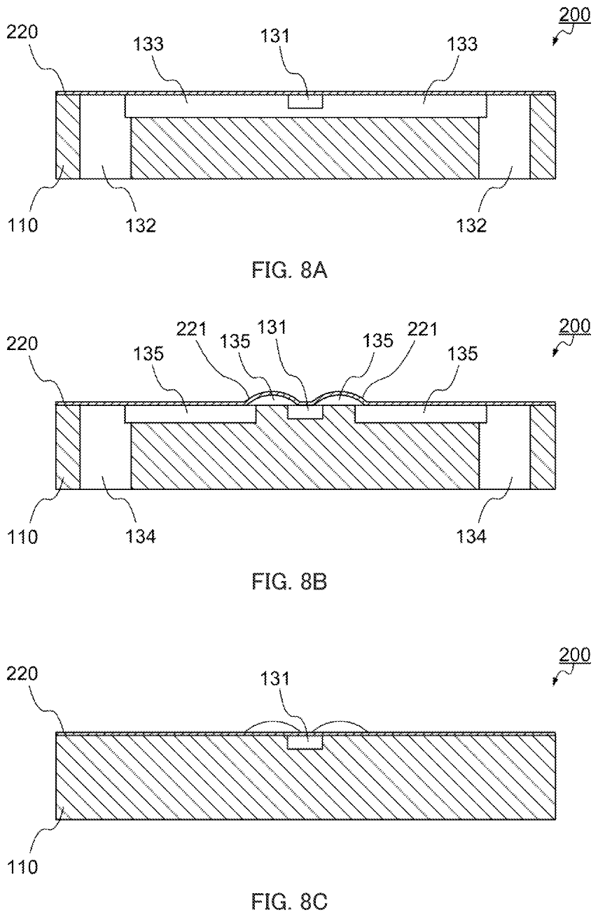

FIG. 6 is a perspective view of liquid handling device 200 according to Embodiment 2. FIG. 7A is a plan view of liquid handling device 200, and FIG. 7B is a sectional view taken along line A-A of FIG. 7A. FIG. 8A is a sectional view taken along line B-B of FIG. 7A, FIG. 8B is a sectional view taken along line C-C of FIG. 7A, and FIG. 8C is a sectional view taken along line D-D of FIG. 7A.

As illustrated in these drawings, liquid handling device 200 includes substrate 110 and film 220. In substrate 110, a groove configured to be a channel and a through hole configured to be an inlet or an outlet are formed. Film 220 is joined to one surface of substrate 110 to close the openings of the groove and the through hole formed in substrate 110. A part of the region of film 220 is formed as curved portion 221 curved in a direction away from substrate 110. The groove of substrate 110 closed with film 220 serves as a channel for carrying main liquid or sheath liquid. In addition, the inner space of curved portion 221 also serves as a channel for carrying sheath liquid.

In the present embodiment, liquid handling device 200 includes main liquid introduction part 130, main channel 131, two first sheath liquid introduction parts 132, two first sheath liquid channels 133, two second sheath liquid introduction parts 134, two second sheath liquid channels 235, and liquid ejection part 136.

The upstream ends of two second sheath liquid channels 135 are connected to respective second sheath liquid introduction parts 134 different from each other, and the downstream ends of two second sheath liquid channels 135 are connected to main channel 131. In the present embodiment, two second sheath liquid channels 135 open only to the top surface of main channel 131 (see FIG. 8B). The openings of two second sheath liquid channels 135 at the top surface of main channel 131 are disposed at respective separate positions different from each other.

Except for the portion of the confluence part with main channel 131, second sheath liquid channel 135 is composed of third groove 116 formed in substrate 110 and a part of film 220 that closes the opening of third groove 116 (see FIGS. 2 and 8B).

The confluence part of second sheath liquid channel 135 with main channel 131 is composed of a part of one surface of substrate 110 (the surface on which film 220 is joined), a part of the opening of first groove 112 (the groove that makes up main channel 131), and curved portion 221 of film 220 (FIGS. 2 and 8B). In the present embodiment, film 220 includes two curved portions 221. The shape of each of two curved portions 221 is a substantially spherical cap shape (see FIGS. 7A and 8B).

### Operation of Liquid Handling Device

Liquid handling device 200 according to Embodiment 2 can be used through a procedure similar to that of liquid handling device 100 according to Embodiment 1.

### Effect

Liquid handling device 200 according to Embodiment 2 has an effect similar to that of liquid handling device 100 according to Embodiment 1.

### Embodiment 3

Liquid handling device 300 according to Embodiment 3 is different from liquid handling device 100 according to Embodiment 1 only in configurations of second sheath liquid introduction part 334 and second sheath liquid channel 335. The same components as those of liquid handling device 100 according to Embodiment 1 are denoted by the same reference numerals, and the descriptions thereof are omitted.

### Configuration of Liquid Handling Device

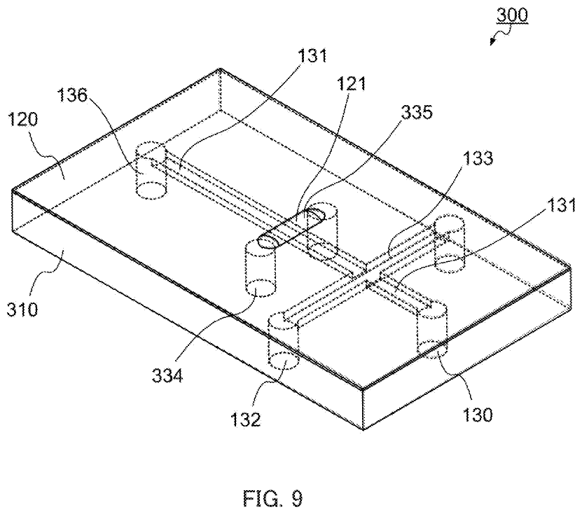

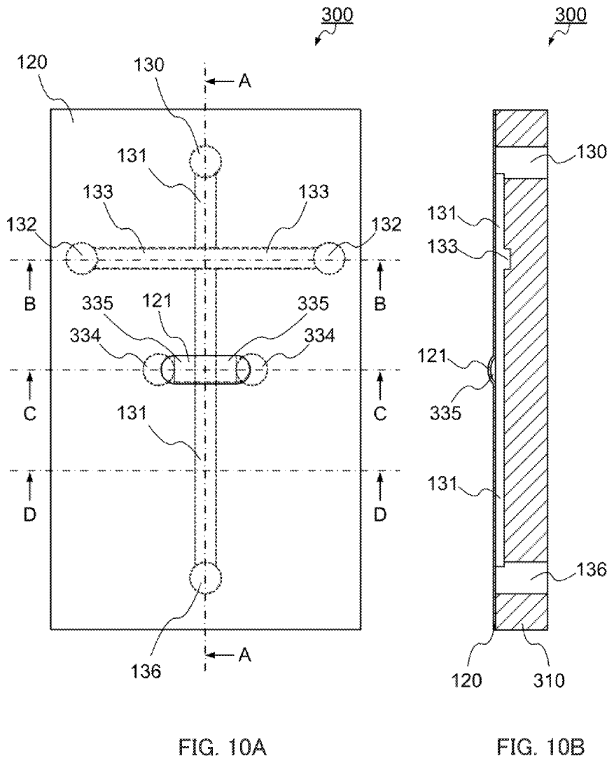

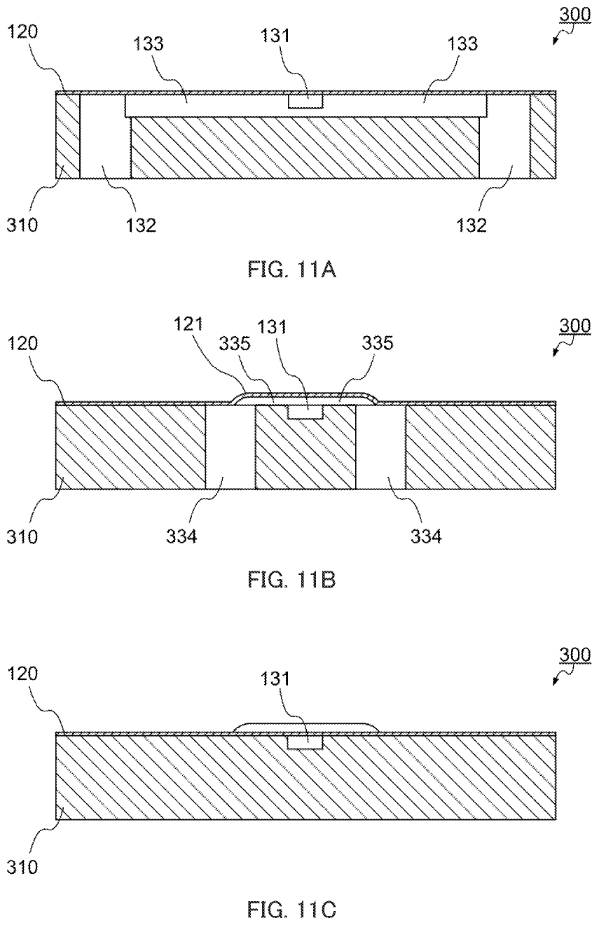

FIG. 9 is a perspective view of liquid handling device 300 according to Embodiment 3. FIG. 10A is a plan view of liquid handling device 300, and FIG. 10B is a sectional view taken along line A-A of FIG. 10A. FIG. 11A is a sectional view taken along line B-B of FIG. 10A, FIG. 11B is a sectional view taken along line C-C of FIG. 10A, and FIG. 11C is a sectional view taken along line D-D of FIG. 10A.

As illustrated in these drawings, liquid handling device 300 includes substrate 310 and film 120. In substrate 310, a groove configured to be a channel and a through hole configured to be an inlet or an outlet are formed. Film 120 is joined to one surface of substrate 310 to close the openings of the groove and the through hole formed in substrate 310. A part of the region of film 120 is formed as curved portion 121 curved in a direction away from substrate 110. The groove of substrate 310 closed with film 120 serves as a channel for carrying main liquid or sheath liquid. In addition, the inner space of curved portion 121 also serves as a channel for carrying sheath liquid.

In the present embodiment, liquid handling device 300 includes main liquid introduction part 130, main channel 131, two first sheath liquid introduction parts 132, two first sheath liquid channels 133, two second sheath liquid introduction parts 334, two second sheath liquid channels 335, and liquid ejection part 136.

Two second sheath liquid introduction parts 334 are bottomed recesses to which the sheath liquid is introduced. In the present embodiment, each of two second sheath liquid introduction parts 334 is composed of third through hole 115 formed in substrate 110, and a part of film 120 that closes one opening of third through hole 115 (see FIG. 2). In the present embodiment, an end portion of curved portion 121 of film 120 faces one opening of third through hole 115.

Two second sheath liquid channels 335 are channels in which liquid can move. The upstream ends of two second sheath liquid channels 335 are connected to respective second sheath liquid introduction parts 334 different from each other, and the downstream ends of two second sheath liquid channels 335 are connected to main channel 131. In the present embodiment, two second sheath liquid channels 335 open only to the top surface of main channel 131 (see FIG. 11B). Openings of two second sheath liquid channels 335 at the top surface of main channel 131 is a common opening.

In the present embodiment, second sheath liquid channel 335 is composed of a part of one surface of substrate 310 (the surface on which film 120 is joined), a part of the opening of third through hole 115 (the through hole that makes up second sheath liquid introduction part 334), a part of the opening of first groove 112 (the groove that makes up main channel 131), and curved portion 121 of film 120 (see FIGS. 2 and 11B). Accordingly, in the present embodiment, the sheath liquid introduced to second sheath liquid introduction part 334 is introduced into main channel 131 from the top surface side of main channel 131 through the space between substrate 310 and curved portion 121.

### Operation of Liquid Handling Device

Liquid handling device 300 according to Embodiment 3 can be used through a procedure similar to that of liquid handling device 100 according to Embodiment 1.

### Effect

Liquid handling device 300 according to Embodiment 3 has an effect similar to that of liquid handling device 100 according to Embodiment 1.

### Embodiment 4

### Configuration of Liquid Handling Device

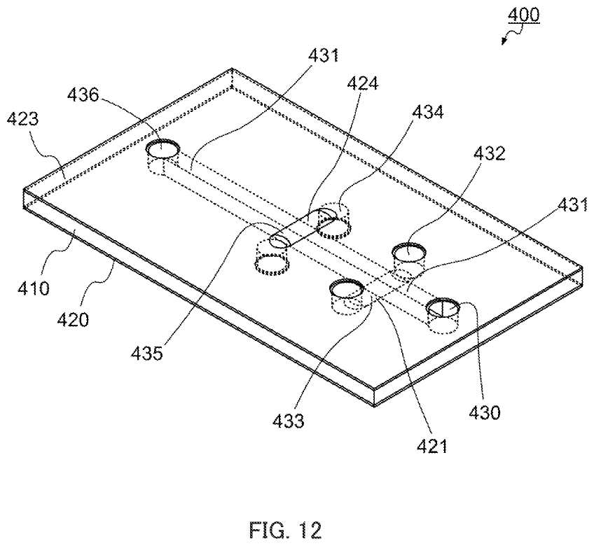

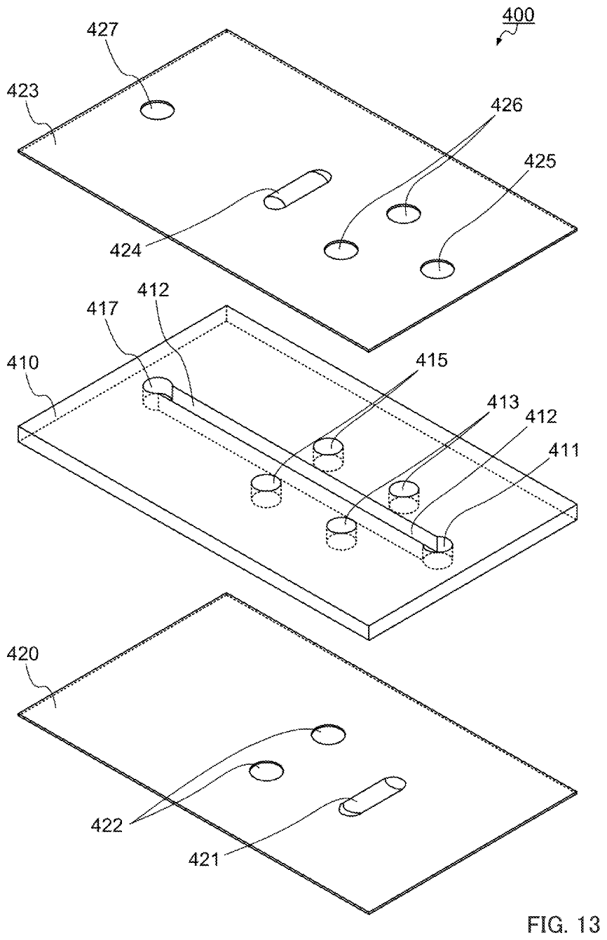

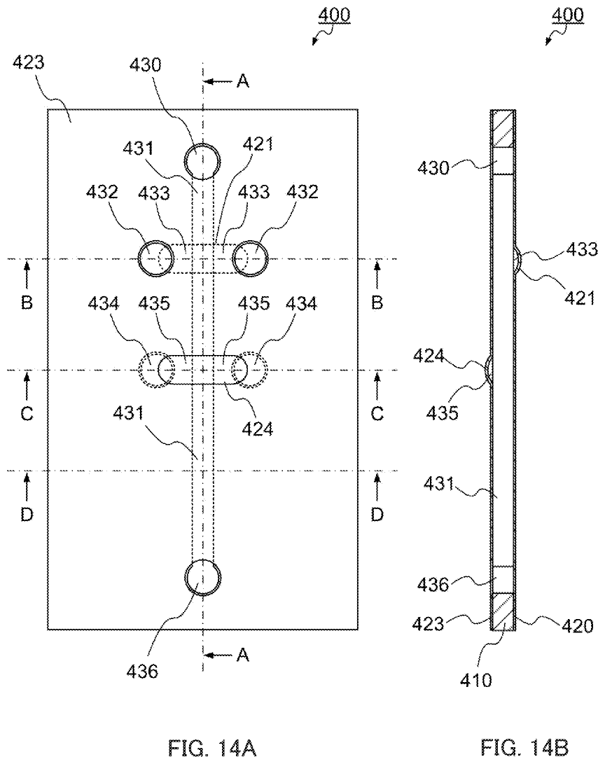

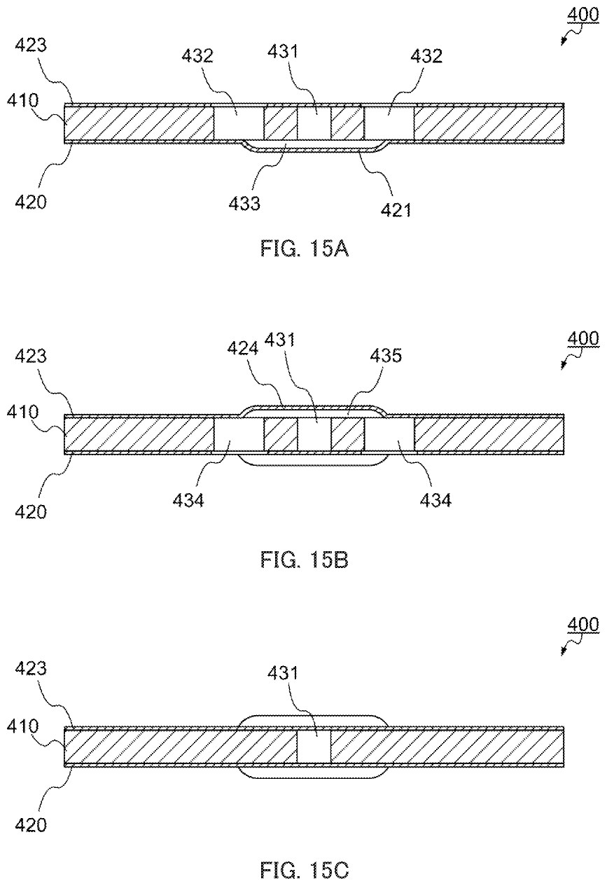

FIG. 12 is a perspective view of liquid handling device 400 according to Embodiment 4. FIG. 13 is an exploded perspective view of liquid handling device 400. FIG. 14A is a plan view of liquid handling device 400, and FIG. 14B is a sectional view taken along line A-A of FIG. 14A. FIG. 15A is a sectional view taken along line B-B of FIG. 14A, FIG. 15B is a sectional view taken along line C-C of FIG. 14A, and FIG. 15C is a sectional view taken along line D-D of FIG. 14A.

As illustrated in these drawings, liquid handling device 400 includes substrate 410, first film 420 and second film 423. In substrate 410, a slit configured to be a channel and a through hole configured to be an inlet or an outlet are formed. First film 420 is joined to one surface of substrate 410 to close the openings of the slit and the through hole formed in substrate 410. A part of the region of first film 420 is formed as first curved portion 421 curved in a direction away from substrate 410. Second film 423 is joined to the other surface of substrate 410 to close the openings of the slit and the through hole formed in substrate 410. A part of the region of second film 423 is formed as second curved portion 424 curved in a direction away from substrate 410. The slit of substrate 410 closed with first film 420 and second film 423 serves as a channel for carrying the main liquid. In addition, the inner space of first curved portion 421 and the inner space of second curved portion 424 serve as channels for carrying the sheath liquid.

The thickness of substrate 410 is not limited. For example, the thickness of substrate 410 is 1 mm to 10 mm In addition, the material of substrate 410 is not limited. For example, the material of substrate 110 may be appropriately selected from publicly known resins and glass. Examples of the material of substrate 410 include polyethylene terephthalate, polycarbonate, polymethylmethacrylate, polyvinyl chloride, polypropylene, polyether, polyethylene, polystyrene, cycloolefin resin, silicone resin and elastomer.

The thickness of each of first film 420 and second film 423 is not limited as long as a required strength can be ensured. For example, each of first film 420 and second film 423 has a thickness of 30 μm to 300 μm. In addition, the material of first film 420 and second film 423 is not limited as long as first curved portion 421 or second curved portion 424 can be molded. For example, the material of first film 420 and second film 423 may be appropriately selected from publicly known resins. Examples of the material of first film 420 and second film 423 include polyethylene terephthalate, polycarbonate, polymethylmethacrylate, polyvinyl chloride, polypropylene, polyether, polyethylene, polystyrene, cycloolefin resin, silicone resin and elastomer. For observation of the main liquid flowing inside the channel, it is preferable that the material of at least one of first film 420 and second film 423 be transparent. In addition, for fluorescence observation of the main liquid flowing inside the channel, it is preferable that the material of at least one of first film 420 and second film 423 be a material that transmits excitation light and fluorescence, with low autofluorescence. First film 420 and second film 423 are joined to substrate 410 by, for example, thermal welding, laser welding, an adhesive agent and the like.

In the present embodiment, liquid handling device 400 includes main liquid introduction part 430, main channel 431, two first sheath liquid introduction parts 432, two first sheath liquid channels 433, two second sheath liquid introduction parts 434, two second sheath liquid channels 435, and liquid ejection part 436.

Main liquid introduction part 430 is a bottomed recess to which the main liquid is introduced. In the present embodiment, main liquid introduction part 430 is composed of first through hole 411 formed in substrate 410, first through hole 425 formed in second film 423, and a part of first film 420 that closes one opening of first through hole 411 (see FIG. 13). The shape and the size of first through hole 411 of substrate 410 are not limited, and may be appropriately set in accordance with the use. The shape of first through hole 411 of substrate 410 is, for example, a substantially columnar shape. The diameter of first through hole 411 of substrate 410 is, for example, approximately 2 mm

Main channel 431 is a channel in which liquid can move. The upstream end of main channel 431 is connected to main liquid introduction part 430, and the downstream end of main channel 431 is connected to liquid ejection part 436. In addition, as described later, first sheath liquid channel 433 and second sheath liquid channel 435 are connected to main channel 431 at respective positions different from each other. In the present embodiment, the main liquid is introduced from main liquid introduction part 430 to main channel 431, and the sheath liquid is introduced from the confluence part with first sheath liquid channel 433 and the confluence part with second sheath liquid channel 435. Accordingly, the main liquid flows in main channel 431 in the region from main liquid introduction part 430 to the confluence part with first sheath liquid channel 433, and the main liquid and the sheath liquid flow in main channel 431 in the region from the confluence part with first sheath liquid channel 433 to liquid ejection part 436. As described later, in the region from the confluence part with second sheath liquid channel 435 to liquid ejection part 436, the main liquid and the sheath liquid flow through main channel 431 in a sheath flow state in which the sheath liquid surrounds the main liquid.

Main channel 431 is composed of slit (slender through hole) 412 formed in substrate 410, a part of first film 420 that closes one opening of slit 412, and a part of second film 423 that closes the other opening of slit 412 (see FIG. 13). The cross-sectional area and the cross-sectional shape of slit 412 are not limited as long as the sheath flow in which the sheath liquid surrounds the main liquid can be formed in main channel 431. The “cross-section of a channel or a slit” as used herein means a cross-section of the channel or the slit orthogonal to the flow direction of liquid. The cross-sectional shape of slit 412 is, for example, a substantially rectangular shape with each side having a length (width and depth) of approximately several tens of micrometers. The cross-sectional area of slit 412 may be or may not be constant in the flow direction of the liquid. In the present embodiment, the cross-sectional area of slit 412 is constant.

Two first sheath liquid introduction parts 432 and two second sheath liquid introduction parts 434 are bottomed recesses to which the sheath liquid is introduced. In the present embodiment, each of two first sheath liquid introduction parts 432 is composed of second through hole 413 formed in substrate 410, second through hole 426 formed in second film 423, and a part of first film 420 that closes one opening of second through hole 413 (see FIG. 13). In addition, each of two second sheath liquid introduction parts 434 is composed of third through hole 415 formed in substrate 410, third through hole 422 formed in first film 420, a part of second film 423 that closes one opening of third through hole 415 (see FIG. 13). The shape and the size of second through hole 413 and third through hole 415 of substrate 410 are not limited, and may be appropriately set in accordance with the use. The shape of each of second through hole 413 and third through hole 415 of substrate 410 is, for example, a substantially columnar shape. The diameter of each of second through hole 413 and third through hole 415 of substrate 410 is, for example, approximately 2 mm

Two first sheath liquid channels 433 are channels in which liquid can move. The upstream ends of two first sheath liquid channels 433 are connected to respective first sheath liquid introduction parts 432 different from each other, and the downstream ends of two first sheath liquid channels 433 are connected to main channel 431. The sheath liquid introduced to first sheath liquid introduction part 432 flows through first sheath liquid channel 433. First sheath liquid channel 433 opens at least to the bottom surface of main channel 431. In the present embodiment, the “bottom surface of a channel” means the surface on first film 420 side (the surface formed with first film 420) of the inner surfaces of the channel. In the present embodiment, two first sheath liquid channels 433 open only to the bottom surface of main channel 431 (see FIGS. 13 and 15A). The openings of two first sheath liquid channels 433 at the bottom surface of main channel 431 are a common opening.

In the present embodiment, two first sheath liquid channels 433 are composed of a part of one surface of substrate 410 (the surface on which first film 420 is joined), a part of the opening of second through hole 413 (the through hole that makes up first sheath liquid introduction part 432), a part of the opening of slit 412 (the slit that makes up main channel 431), and first curved portion 421 of first film 420 (see FIGS. 13 and 15A). As described above, first curved portion 421 is a portion provided in first film 420 and curved (recessed) in a direction away from substrate 410. First curved portion 421 faces the surface, of substrate 410, where the groove is not formed, but is not joined on substrate 410. Accordingly, the sheath liquid introduced to first sheath liquid introduction part 432 is introduced into main channel 431 from the bottom surface side of main channel 431 through the space between substrate 410 and first curved portion 421. The shape and the size of first curved portion 421 are not limited as long as an appropriate amount of the sheath liquid for forming the sheath flow can be introduced to main channel 431. In the present embodiment, the shape of first curved portion 421 in plan view is a substantially ellipsoidal shape (a shape with two parallel lines of the same length and two semicircles)(see FIG. 14A). The cross-sectional shape of first curved portion 421 taken along the minor axis direction is a substantially arc shape (see FIG. 14B).

Two second sheath liquid channels 435 are channels in which liquid can move. The upstream ends of two second sheath liquid channels 435 are connected to respective second sheath liquid introduction parts 434 different from each other, and the downstream ends of two second sheath liquid channels 435 are connected to main channel 431. The sheath liquid introduced to second sheath liquid introduction part 434 flows through second sheath liquid channel 435. Second sheath liquid channel 435 opens at least to the top surface of main channel 431. In the present embodiment, the “top surface of a channel” means the surface on second film 423 side (the surface formed with second film 423) of the inner surfaces of the channel In the present embodiment, two second sheath liquid channels 435 open only to the top surface of main channel 431 (see FIGS. 13 and 15B). The openings of two second sheath liquid channels 435 at the top surface of main channel 431 are a common opening.

In the present embodiment, two second sheath liquid channels 435 are composed of a part of the other surface of substrate 410 (the surface on which second film 423 is joined), a part of the opening of third through hole 415 (the through hole that makes up second sheath liquid introduction part 434), a part of the opening of slit 412 (the slit that makes up main channel 431), and second curved portion 424 of second film 423 (see FIGS. 13 and 15A). As described above, second curved portion 424 is a portion provided in second film 423 and curved (recessed) in a direction away from substrate 410. Second curved portion 424 faces the surface, of substrate 410, where the groove is not formed, but is not joined on substrate 410. Accordingly, the sheath liquid introduced to second sheath liquid introduction part 434 is introduced into main channel 431 from the top surface side of main channel 431 through the space between substrate 410 and second curved portion 424. The shape and the size of second curved portion 424 are not limited as long as an appropriate amount of the sheath liquid for forming the sheath flow can be introduced to main channel 431. In the present embodiment, the shape of second curved portion 424 in plan view is a substantially ellipsoidal shape (a shape with two parallel lines of the same length and two semicircles)(see FIG. 14A). The cross-sectional shape of first curved portion 421 taken along the minor axis direction is a substantially arc shape (see FIG. 14B).

Note that while the confluence part of two first sheath liquid channels 433 is located upstream of the confluence part of two second sheath liquid channels 435 in main channel 431 in the present embodiment, the positions of these confluence parts are not limited to this. For example, the confluence part of two second sheath liquid channels 435 may be disposed upstream of the confluence part of two first sheath liquid channels 433. In addition, the confluence part of two first sheath liquid channels 433 may face the confluence part of two second sheath liquid channels 435.

Liquid ejection part 436 is a bottomed recess for removing the main liquid and the sheath liquid flowing in from main channel 431 in the sheath flow state. In the present embodiment, liquid ejection part 436 is composed of fourth through hole 417 formed in substrate 410, fourth through hole 427 formed in second film 423, and a part of first film 420 that closes one opening of fourth through hole 417 (see FIG. 13). The shape and the size of fourth through hole 417 of substrate 410 are not limited, and may be appropriately set in accordance with the use. The shape of fourth through hole 417 of substrate 410 is, for example, a substantially columnar shape. The diameter of fourth through hole 417 of substrate 410 is, for example, approximately 2 mm

### Operation of Liquid Handling Device

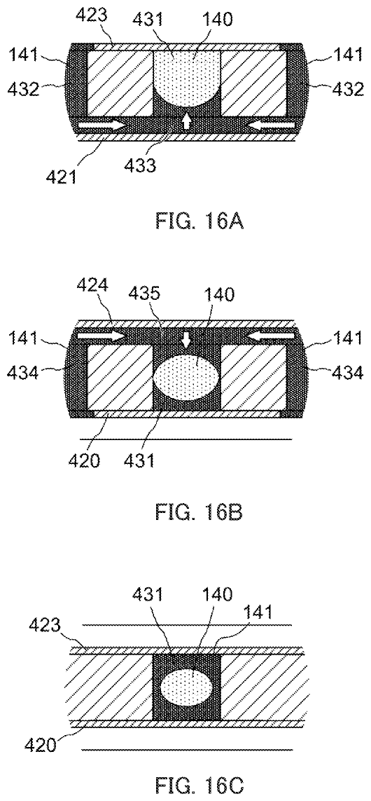

Next, with reference to FIGS. 16A to 16C, an operation (liquid handling method) of liquid handling device 400 is described.

The main liquid is introduced to main liquid introduction part 430 and the sheath liquid is introduced to two first sheath liquid introduction parts 432 and two second sheath liquid introduction parts 434. In this state, liquid ejection part 436 is depressurized, or a pressure is exerted on main liquid introduction part 430, two first sheath liquid introduction parts 432 and two second sheath liquid introduction parts 434. In this manner, the main liquid in main liquid introduction part 430 flows toward liquid ejection part 436 in main channel 431. In addition, the sheath liquid in first sheath liquid introduction part 432 flows toward main channel 431 in first sheath liquid channel 433, and the sheath liquid in second sheath liquid introduction part 434 flows toward main channel 431 in second sheath liquid channel 435.

FIG. 16A is a drawing illustrating main liquid 140 and sheath liquid 141 at the confluence part of main channel 431 and two first sheath liquid channels 433 (which corresponds to a partially enlarged view of the vicinity of main channel 431 illustrated in FIG. 15A). As illustrated in this drawing, two first sheath liquid channels 433 open to the bottom surface of main channel 431, and therefore, at the confluence part of main channel 431 and two first sheath liquid channels 433, sheath liquid 141 flowing in from two first sheath liquid channels 433 is located on the lateral side and the lower side of main liquid 140 in main channel 431, but not located on the upper side. The cross-sectional shape of first curved portion 421 taken along the minor axis direction is a substantially arc shape (see FIG. 14B), and therefore, at the confluence part of main channel 431 and two first sheath liquid channels 433, sheath liquid 141 can be located not only on the lower side but also on the lateral side of the main liquid 140 while slightly expanding to first curved portion 421 side. In main channel 431, main liquid 140 and sheath liquid 141 flow in a laminar flow state.

FIG. 16B is a drawing illustrating main liquid 140 and sheath liquid 141 at the confluence part of main channel 431 and two second sheath liquid channels 435 (which corresponds to a partially enlarged view of the vicinity of the main channel 431 illustrated in FIG. 15B). As illustrated in this drawing, two second sheath liquid channels 435 open to the top surface of main channel 431, and therefore, at the confluence part of main channel 431 and two second sheath liquid channels 435, sheath liquid 141 flowing in from two second sheath liquid channels 435 is located on the lateral side and the upper side of main liquid 140 in main channel 431. The cross-sectional shape of second curved portion 424 taken along the minor axis direction is a substantially arc shape (see FIG. 14B), and therefore, at the confluence part of main channel 431 and two second sheath liquid channels 435, sheath liquid 141 can be located not only on the upper side but also on the lateral side of main liquid 140 while slightly expanding to second curved portion 424 side. In main channel 431, sheath liquid 141 flowing in from two second sheath liquid channels 435 also flows in a laminar flow state.

FIG. 16C is a drawing illustrating main liquid 140 and sheath liquid 141 in main channel 431 downstream of the confluence part of main channel 431 and two second sheath liquid channels 435 (which corresponds to a partially enlarged view of the vicinity of main channel 431 illustrated in FIG. 15C). As described above, sheath liquid 141 flowing in from two first sheath liquid channels 433 is located on the lateral side and the lower side of main liquid 140 in main channel 431 (see FIG. 16A), and sheath liquid 141 flowing in from two second sheath liquid channels 435 is located on the lateral side and the upper side of main liquid 140 in main channel 431 (see FIG. 16B). As a result, as illustrated in FIG. 16C, a sheath flow in which sheath liquid 141 surrounds main liquid 140 is formed.

Observation or fluorescence observation of main liquid 140 may be performed in the state where the sheath flow is formed in main channel 431 as illustrated in FIG. 16C. Since main liquid 140 stably flows in the state where it is surrounded by sheath liquid 141 without making contact with the inner wall of main channel 431, main liquid 140 can be stably observed.

### Effect

Liquid handling device 400 according to Embodiment 4 has an effect similar to that of liquid handling device 100 according to Embodiment 1.

### INDUSTRIAL APPLICABILITY

The liquid handling device of the embodiments of the present invention is useful for various uses such as laboratory tests, food tests, and environment tests, for example.

### REFERENCE SIGNS LIST

100, 200, 300, 400 Liquid handling device
110, 310, 410 Substrate
111, 411 First through hole
112 First groove
113, 413 Second through hole
114 Second groove
115, 415 Third through hole
116 Third groove
117, 417 Fourth through hole
120, 220 Film
121, 221 Curved portion
130, 430 Main liquid introduction part
131, 431 Main channel
132, 432 First sheath liquid introduction part
133, 433 First sheath liquid channel
134, 334, 434 Second sheath liquid introduction part
135, 335, 435 Second sheath liquid channel
136, 436 Liquid ejection part
140 Main liquid
141 Sheath liquid
412 Slit
420 First film
421 First curved portion
422 Third through hole
423 Second film
424 Second curved portion
425 First through hole
426 Second through hole
427 Fourth through hole

What is claimed is:

1. A liquid handling device configured to form a sheath flow including main liquid and sheath liquid surrounding the main liquid, the liquid handling device comprising:
a substrate;
a film joined to the substrate;
a main channel configured to carry the main liquid;
a first sheath liquid channel that opens to a bottom surface of the main channel, the first sheath liquid channel being configured to carry the sheath liquid; and
a second sheath liquid channel that opens to a top surface of the main channel, the second sheath liquid channel being configured to carry the sheath liquid,
wherein at least one of a confluence part of the first sheath liquid channel with the main channel and a confluence part of the second sheath liquid channel with the main channel is made up of the substrate and a curved portion of the film, the curved portion of the film being curved in a direction away from the substrate.

2. The liquid handling device according to claim 1,
wherein the main channel is made up of a first groove formed in one surface of the substrate and a part of the film that closes the first groove;
wherein the first sheath liquid channel is made up of a second groove formed in the one surface of the substrate and a part of the film that closes the second groove; and
the confluence part of the second sheath liquid channel with the main channel is made up of a part of the one surface of the substrate, a part of an opening of the first groove, and the curved portion of the film.

3. The liquid handling device according to claim 2, wherein the first sheath liquid channel opens also to two side surfaces of the main channel, the two side surfaces opposing each other.

4. The liquid handling device according to claim 1,
wherein the film includes a first film joined to one surface of the substrate and a second film joined to another surface of the substrate;
wherein the main channel is made up of a slit formed in the substrate, a part of the first film that closes one opening of the slit, and a part of the second film that closes another opening of the slit;
wherein the confluence part of the first sheath liquid channel with the main channel is made up of a part of the one surface of the substrate, a part of the one opening of the slit, and a curved portion of the first film, the curved portion of the first film being curved in a direction away from the substrate; and
wherein the confluence part of the second sheath liquid channel with the main channel is made up of a part of the other surface of the substrate, a part of the other opening of the slit, and a curved portion of the second film, the curved portion of the second film being curved in a direction away from the substrate.

5. A liquid handling method of forming a sheath flow using the liquid handling device according to claim 1, the liquid handling method comprising:
forming a sheath flow including the main liquid and the sheath liquid surrounding the main liquid by carrying the main liquid in the main channel and carrying the sheath liquid in the first sheath liquid channel and the second sheath liquid channel.
